(19) United States
(12) Patent Application Publication
(10) Pub. No.: US 2016/0221407 A1
(43) Pub. Date: Aug. 4, 2016

(54) ROTATIONALLY SLIPPING RUBBER BUSHING WITH AXIAL RETENTION FEATURE

(71) Applicant: Trelleborg Automotive USA, Inc., South Haven, MI (US)

(72) Inventor: Steven Carleton Molesworth, South Haven, MI (US)

(21) Appl. No.: 15/009,361

(22) Filed: Jan. 28, 2016

Related U.S. Application Data
(60) Provisional application No. 62/109,293, filed on Jan. 29, 2015.

(51) Int. Cl. B60G 11/12; F16F 1/38

(52) U.S. Cl. CPC B60G 11/12; F16F 1/3863; F16F 1/3835

(57) ABSTRACT

A bushing is provided having an outer rigid portion and an inner rigid portion concentrically arranged around each other, the inner rigid portion being the innermost component, a flexible portion positioned between the inner rigid portion and the outer rigid portion, the flexible portion configured to space apart the outer rigid portion and the inner rigid portion and each of the outer rigid portion, the inner rigid portion and the flexible portion includes a tapered end configured to connect with a fastener.

### CROSS-REFERENCE TO RELATED APPLICATIONS

The present Utility patent application claims priority benefit of the U.S. provisional application for patent Ser. No. 62/109,293, filed on Jan. 29, 2015, under 35 U.S.C. 119(e).

### FIELD OF THE INVENTION

The present invention relates generally to bushings. More particularly, the present invention relates to a bushing adapted for use in leaf spring eyes.

### BACKGROUND OF THE INVENTION

Current rubber bushings typically used in leaf springs are made of a rubber over molded inner metal and an outer metal. The assembly is press fit into the outer metal and then the outer metal is roll crimped inward at its distal ends. The bushing is then press fit into its location in the vehicle (typically a leaf spring eye) where it is rigidly connected to the rest of the vehicle via a bolt and a nut. Movement of the vehicle causes relative motion between the molded assembly (the rubber bonded to the inner metal) and the outer metal. For proper vehicle performance, the bushing must accommodate the loads in its radial and longitudinal or axial directions as well as rotation about its longitudinal axis, herein referred to as the torsional direction. Current bushings of the prior art can handle radial and torsional loads sufficiently, but lack an adequate axial retention feature. A longitudinal load can cause the rubber to deform around the outer metal's crimp and allow the molded assembly to become dislodged at relatively low loads (less than 5 kN).

The assembly of the prior art as illustrated typically includes an elongated and an inner metal portion. The inner metal portion includes an over molded rubber positioned between the inner metal and the outer metal. The outer metal is crimped at each of its distal ends. This configuration causes the rubber to deform around the outer metal and allows the assembly to become dislodged.

Accordingly, there exists a need in the art to overcome this deficiency while achieving the ideal rotational compliance. While achieving the ideal rotational compliance of zero has proven to require a more complex concept, there exists a need in the art to provide axial retention. A lack of axial retention forces manufacturers to design the bushings for higher rotational compliances which result in poor vehicle performance.

### SUMMARY

In one embodiment, a bushing is provided having an outer rigid portion and an inner rigid portion concentrically arranged around each other, the inner rigid portion being the innermost component, a flexible portion positioned between the inner rigid portion and the outer rigid portion, the flexible portion configured to space apart the outer rigid portion and the inner rigid portion and each of the outer rigid portion, the inner rigid portion and the flexible portion includes a tapered end configured to connect with a fastener.

The flexible portion may be a bonded rubber where the bonded rubber bonded to at least one of the outer rigid portion or the inner rigid portion. The bonded rubber of the flexible portion may include a textured outer surface where the textured outer surface positioned adjacent to an inner surface of the outer rigid component. An outer surface of the flexible portion includes a plurality of ridges positioned adjacent to an inner surface of the outer rigid component. The outer metal portion includes a main cylindrical section extending to tapered end. The rigid inner portion and the rigid outer portion are made from a material selected from the following: metal, plastic and/or polymer.

In one embodiment, the flexible portion is a rubber, the outer rigid portion is metal and the inner rigid portion is metal where the rubber of the flexible portion is bonded to at least one of the outer rigid portion and the inner rigid portion. The outer rigid portion is concentrically arranged around the flexible portion, the flexible portion is concentrically arranged around the inner rigid portion wherein each of the outer rigid portion, the flexible portion and the inner rigid portion include a central bore, the inner rigid portion configured to receive the fastener.

In another embodiment, a bushing assembly is provided having a first component and a second component. The first component has a first outer metal portion, a first inner metal portion and a first rubber portion concentrically arranged around each other, the first rubber portion spacing apart the first outer metal portion from the first inner metal portion. At least one of the first outer metal portion, the first inner metal portion and the first rubber portion having a first tapered end. The second component has a second outer metal portion, a second inner metal portion and a second rubber portion concentrically arranged around each other, the second rubber portion spacing apart the second outer metal portion from the second inner metal portion. At least one of the second outer metal portion, the second inner metal portion and the second rubber portion having a second tapered end. A fastener configured to connect the first tapered end of the first component and the second tapered end of the second component, the first component and the second component configured to at least partially overlap wherein the bushing assembly forms a bottleneck shaped center portion when fully assembled.

The first and second outer metal portions are concentrically arranged around the respective first and second rubber portions. Further, the first and second rubber portions are concentrically arranged around the respective first and second inner metal portion. The first and second inner metal portions are configured to receive the fastener.

In one embodiment, a rubber of the first rubber portion is bonded to at least one of the first outer metal portion or the first inner metal portion. Further, a rubber of the second rubber portion is bonded to at least one of the second outer metal portion or the second inner metal portion. The bonded rubber of the rubber portion includes a textured outer surface, the textured outer surface positioned adjacent to an inner surface of the outer metal component. In another embodiment, an outer surface of the rubber portion includes a plurality of ridges where the plurality of ridges positioned adjacent to an inner surface of the outer metal component.

In another embodiment, a leaf spring assembly includes a leaf spring having an eye positioned at a free end, the eye configured to hold a bushing. The bushing having a first component connected to a second component. The first component having a first outer metal portion, a first inner metal portion and a first rubber portion concentrically arranged around each other, the first rubber portion spacing apart the first outer metal portion from the first inner metal portion. At least one of the first outer metal portion, the first inner metal portion and the first rubber portion having a first tapered end. The second component having a second outer metal portion, a second inner metal portion and a second rubber portion concentrically arranged around each other, the second rubber portion spacing apart the second outer metal portion from the second inner metal portion. At least one of the second outer metal portion, the second inner metal portion and the second rubber portion having a second tapered end. A fastener is provided configured to connect the first tapered end of the first component and the second tapered end of the second component, the first component and the second component configured to at least partially overlap wherein the bushing assembly forms a bottleneck shaped center portion when fully assembled

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which

FIG. 1A illustrates a side view of the assembled bushing of the present invention;

FIG. 1B illustrates a reverse configuration of the assembly bushing in accordance with one or more embodiments shown and described herein;

FIG. 2A illustrates an environmental view of the bushing of the present invention used in a leaf spring assembly;

FIG. 2B illustrates an exploded perspective view of the bushing and leaf spring assembly;

FIG. 3 illustrates a cross-sectional view of the inner metal component of the bushing of the present invention;

FIG. 4 illustrates a top view of the inner metal component of the bushing of the present invention;

FIG. 5 illustrates a cross-sectional view of the inner metal component of the bushing of the present invention;

FIG. 6 illustrates a perspective view of the inner metal component of the bushing of the present invention;

FIG. 7 illustrates a cross-sectional view of the outer metal component of the bushing of the present invention;

FIG. 8 illustrates a perspective view of the outer metal component of the present invention;

FIG. 9 illustrates a top view of the molded assembly including the inner metal having the molded rubber on the exterior of the inner metal;

FIG. 10 illustrates a side view of the molded assembly;

FIG. 11 illustrates an alternative cross-sectional view of the molded assembly along the line A-A as shown in FIG. 9;

FIG. 12 illustrates a cross-sectional view of the molded assembly;

FIG. 13 illustrates a perspective view of the molded assembly of the bushing of the present invention;

FIG. 14 illustrates a top view of the final bushing assembly;

FIG. 15 illustrates a side view of the final bushing assembly;

FIG. 16 illustrates a cross-sectional view along the line A-A of the final bushing assembly; and

FIG. 17 illustrates a perspective view of the final bushing assembly.

### DETAILED DESCRIPTION OF THE INVENTION

The present invention provides for a bushing for improved longitudinal rotational compliance, axial retention, and near rigid characteristics in all other directions. The bushing includes an outer metal portion, an inner metal portion, and a bonded rubber positioned between the inner metal portion and the outer metal portion. The inner and outer metal portions have bottleneck features adapted to overlap.

The assembly of the present invention provides for a multi assembly bushing having a bottleneck feature in the center of the bushing. The bushing 100 includes outer metal components 102, 104 having outer surfaces 106, 108. The bushing assembly 100 further includes inner metal components 120, 121 positioned to overlap with the outer metal components 102, 104. A molded rubber 132 is positioned between the inner metal components 120, 121 and the outer metal components 102, 104. This assembly utilizes mechanical locking by overlapping the metal components 102, 104 and 120, 121. Both the inner metal components 120, 121 and the outer metal components 102, 104 have a bottleneck feature 110, 112, 130, 131 to create an overlap when the over molded inner metal 120, 121 is pressed into the outer can of the leaf spring assembly, such as illustrated in FIG. 5A and 5B. A single bushing of the prior art is replaced by two bottleneck bushings 100a, 100b facing opposite ways and occupying the same general space within the can of the leaf spring assembly. The leaf spring assembly 200 includes a main leaf spring portion along with the eye 204 of the leaf spring. The bushing 100a, 100b are inserted into the eye 204 and connected together at the inner portions of the bushings 100a, 100b. A fastener (or multiple fasteners) 116 are inserted into the center bore 114 of the bushing to secure the bushings. For either a positive or negative axial loading, the mechanical interlock from one of the halves retains the bushing assembly. This feature also allows for minimal compression of the rubber, thus increasing rotational compliance.

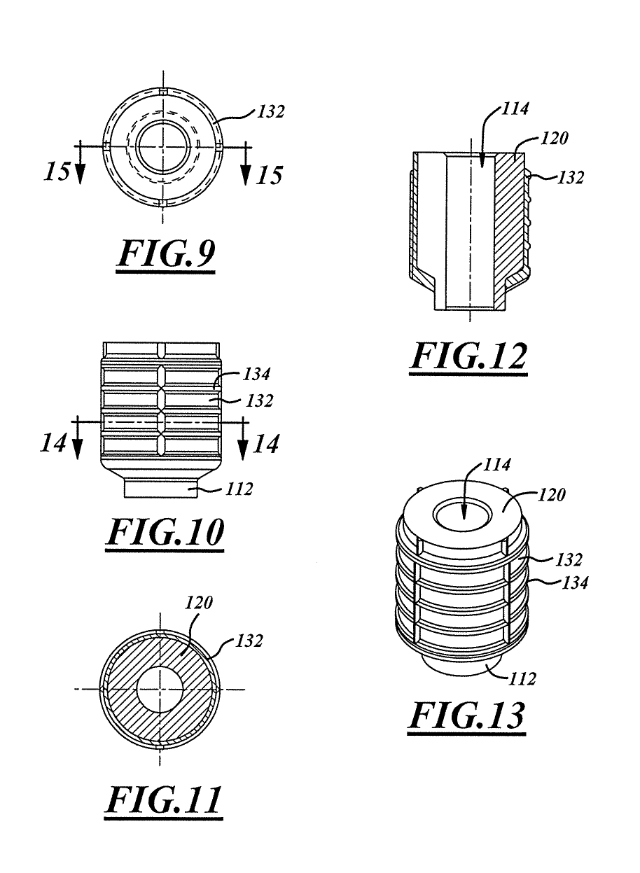

The inner metal components 120, 121 are illustrated in FIGS. 6-9. The inner metal component 120 includes a center bore 114 extending through the entire length of the inner metal 120. The inner metal 120 includes a first portion 124 and a bottlenecked portion 112. The first portion 124 is larger in diameter as compared to the bottlenecked portion 112. As illustrated in FIGS. 6 and 8, the bottlenecked portion is gradual thus changing the diameter from the first portion 124 to the bottlenecked portion 112 at an angle as illustrated by reference numeral 140. In the final assembly, two inner metal portions 120, 121 are provided.

The outer metal portions 102, 104 are larger in diameter as compared to the inner metal 120, 121. The outer metal portion 104 includes a large center portion 126 adapted to receive the inner metal 120, 121. The center portion 126 is generally cylindrical having a smooth interior surface. The outer metal 104 includes an outer surface 108 (the outer metal portion 102 having an outer surface 106) which is also generally smooth. A bottleneck feature 130, 131 is illustrated as tapering down from the larger portion 104a to lower diameter portion 104b, which is the bottleneck feature. This taper is illustrated at reference numeral 128.

In the present embodiment, the outer metal is SAE J1392 XLF340 steel, but could be any grade of stamping steel or aluminum. Further in this present embodiment, the inner metal is ASTM 1040 steel, but could be any material that meets the clamp load requirements and does not provide noticeable creep. Any of the rubber components of the present invention could be replaced with plastic, polymer, plastic-like or polymer-like materials. In the present embodiment, the bonded rubber has a durometer ranging from 40-80 ShoreA. In this specific bonder rubber component, the durometer ranger between 60-75 ShoreA.

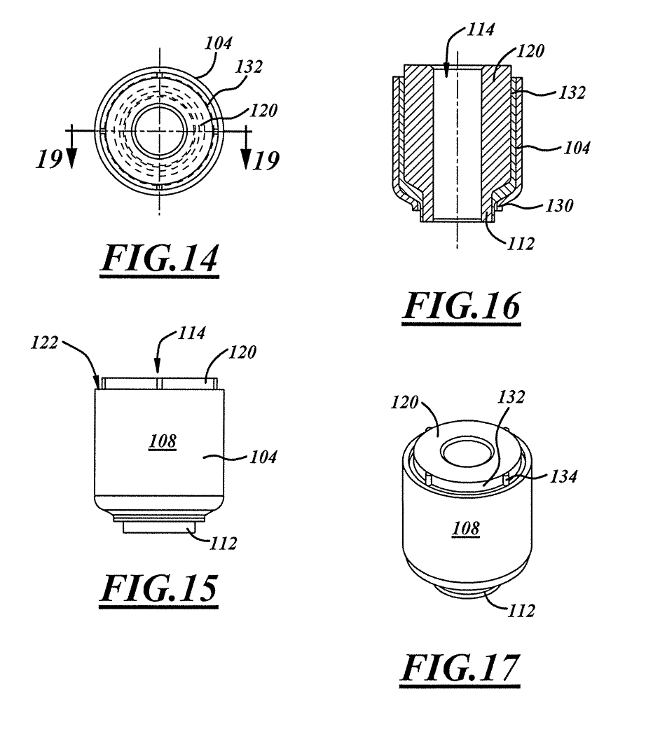

Rubber is molded into a thin layer over and bonded to the inner metal 120, 121. The rubber 132 includes a plurality of ridges 134 adapted to press against the inner surface of the outer metal. In alternative embodiments, the rubber 132 is smooth or has various other different textures to accommodate the assembly. The molded assembly having the rubber 132 molded to the inner metal portion 120 is illustrated in FIGS. 12-16. This molded assembly as illustrated in FIGS. 12-16 is press fit into the outer metal 102, 104 as illustrated in FIGS. 10-11.

The final assembly as illustrated in FIGS. 17-20 is pushed into an outer can of a leaf spring assembly, such as illustrated in FIG. 5. A mechanical overlap is created between the first bushing assembly portion (or component) 102a and the second bushing assembly (or component) 102b. A bolt 116 is inserted through the inner metals and tightened down with a fastener. A portion of the vehicle's weight is then distributed across the two bushings 100a, 100b. The bottleneck feature prevents the assemblies from dislodging themselves during axial loading and provides for improved performance characteristics as compared to the prior art.

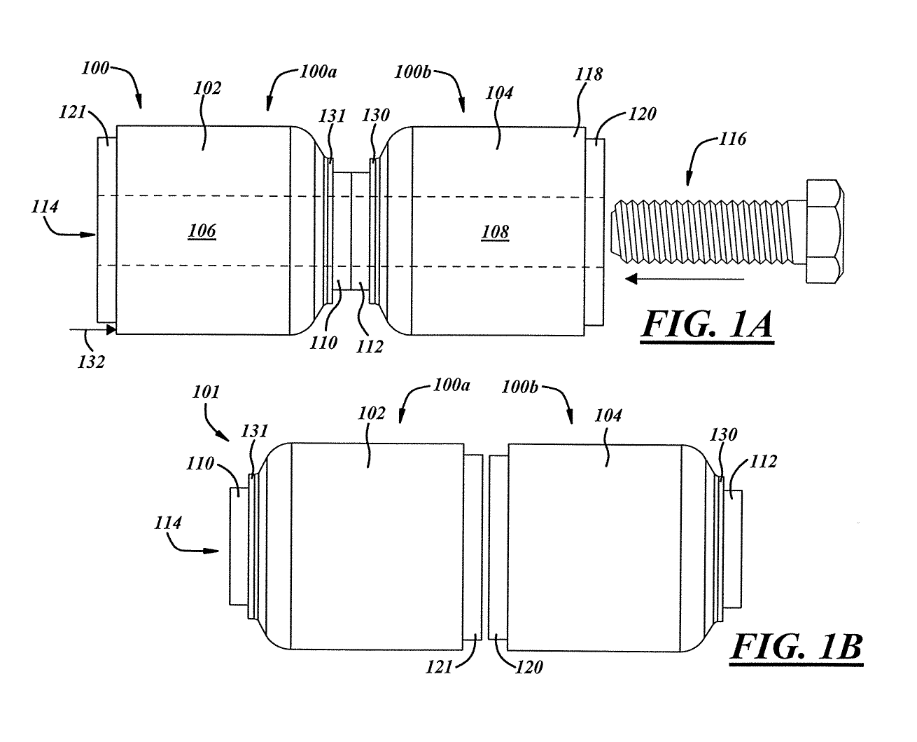

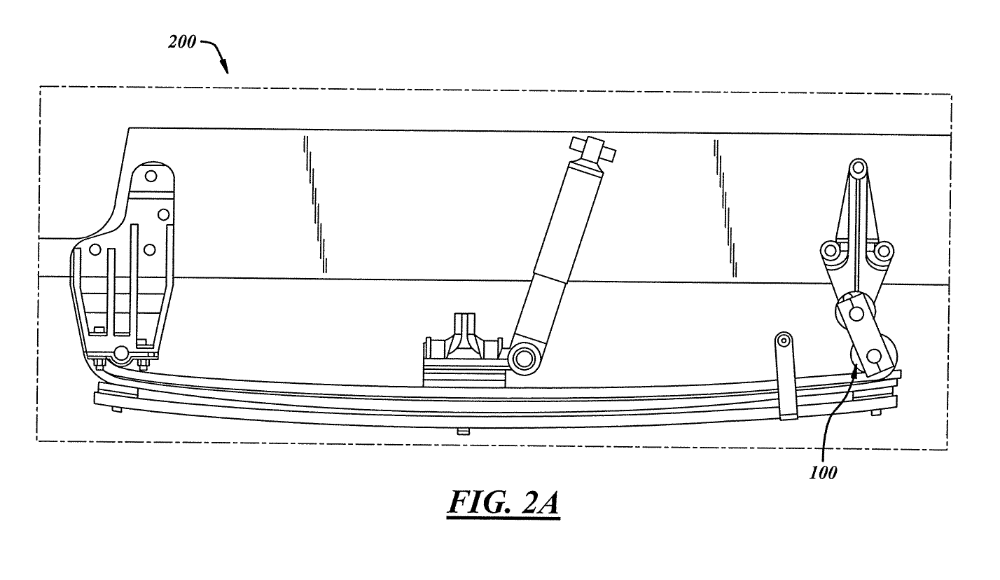

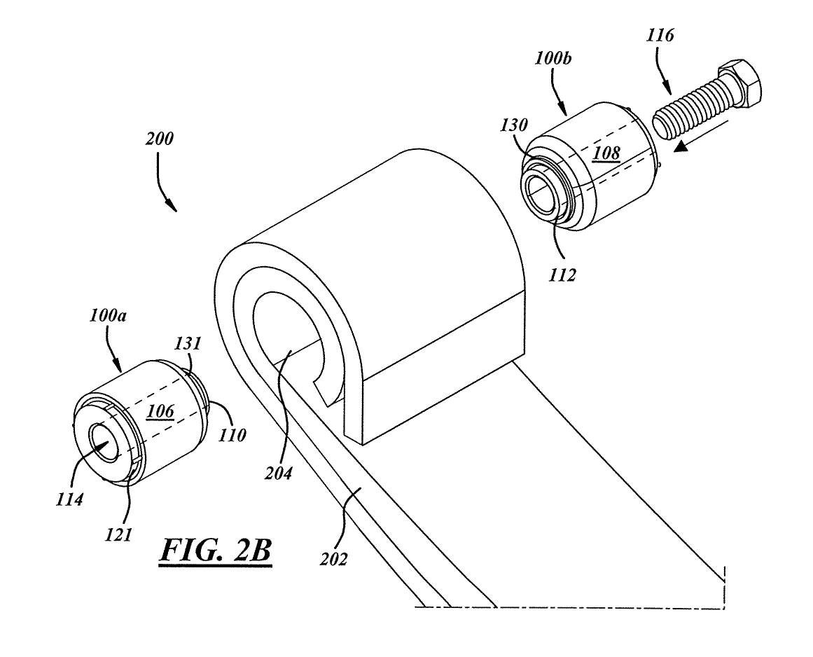

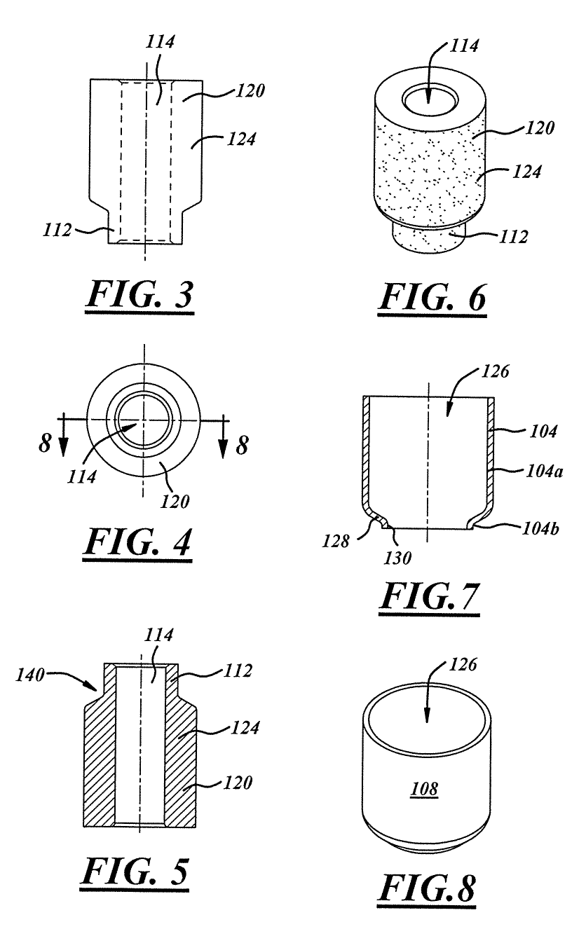

It should be noted that the configuration discussed above may also be reversed. This configuration is illustrated in FIG. 1B at the assembly 101. The configuration of the assembly 101 connects the wider ends 120, 121 instead of the tapered portions. The assembly can be applied to busing with through holes for bolts (such as shown in FIG. 1A) or bar pins which do not extend through the center of the part. Further, the assembly may connect without a fastener by means of overlapping, adhesives, welding or other known connection means.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A bushing comprising:
an outer rigid portion and an inner rigid portion concentrically arranged around each other, the inner rigid portion being the innermost component;
a flexible portion positioned between the inner rigid portion and the outer rigid portion, the flexible portion configured to space apart the outer rigid portion and the inner rigid portion; and
each of the outer rigid portion, the inner rigid portion and the flexible portion having a tapered end configured to connect with a fastener.

2. The bushing of claim 1 wherein the flexible portion is bonded rubber, the bonded rubber bonded to at least one of the outer rigid portion or the inner rigid portion.

3. The bushing of claim 2 wherein the bonded rubber of the flexible portion includes a textured outer surface, the textured outer surface positioned adjacent to an inner surface of the outer rigid component.

4. The bushing of claim 2 wherein an outer surface of the flexible portion includes a plurality of ridges, the plurality of ridges positioned adjacent to an inner surface of the outer rigid component.

5. The bushing of claim 1 wherein the outer metal portion includes a main cylindrical section extending to tapered end.

6. The bushing of claim 1 wherein the rigid inner portion and the rigid outer portion are made from a material selected from the following: metal, plastic and/or polymer.

7. The bushing of claim 1 wherein the flexible portion is a rubber, the outer rigid portion is metal and the inner rigid portion is metal, the rubber of the flexible portion is bonded to at least one of the outer rigid portion and the inner rigid portion.

8. The bushing of claim 1 wherein the outer rigid portion is concentrically arranged around the flexible portion, the flexible portion is concentrically arranged around the inner rigid portion wherein each of the outer rigid portion, the flexible portion and the inner rigid portion include a central bore, the inner rigid portion configured to receive the fastener.

9. A bushing assembly comprising:
a first component having a first outer metal portion, a first inner metal portion and a first rubber portion concentrically arranged around each other, the first rubber portion spacing apart the first outer metal portion from the first inner metal portion, at least one of the first outer metal portion, the first inner metal portion and the first rubber portion having a first tapered end;
a second component having a second outer metal portion, a second inner metal portion and a second rubber portion concentrically arranged around each other, the second rubber portion spacing apart the second outer metal portion from the second inner metal portion, at least one of the second outer metal portion, the second inner metal portion and the second rubber portion having a second tapered end; and
a fastener configured to connect the first tapered end of the first component and the second tapered end of the second component, the first component and the second component configured to at least partially overlap;
wherein the bushing assembly forms a bottleneck shaped center portion when fully assembled.

10. The bushing assembly of claim 9 wherein the first and second outer metal portions are concentrically arranged around the respective first and second rubber portions.

11. The bushing assembly of claim 9 wherein the first and second rubber portions are concentrically arranged around the respective first and second inner metal portion.

12. The bushing assembly of claim 9 wherein the first and second inner metal portions are configured to receive the fastener.

13. The bushing of claim 9 wherein a rubber of the first rubber portion is bonded to at least one of the first outer metal portion or the first inner metal portion.

14. The bushing of claim 9 wherein a rubber of the second rubber portion is bonded to at least one of the second outer metal portion or the second inner metal portion.

15. The bushing of claim 12 wherein the bonded rubber of the rubber portion includes a textured outer surface, the textured outer surface positioned adjacent to an inner surface of the outer metal component.

16. The bushing of claim 12 wherein an outer surface of the rubber portion includes a plurality of ridges, the plurality of ridges positioned adjacent to an inner surface of the outer metal component.

17. The bushing of claim 9 wherein the outer metal portion includes a main cylindrical section extending to tapered end.

18. A leaf spring assembly comprising:
a leaf spring having an eye positioned at a free end, the eye configured to hold a bushing;
the bushing having:
a first component having a first outer metal portion, a first inner metal portion and a first rubber portion concentrically arranged around each other, the first rubber portion spacing apart the first outer metal portion from the first inner metal portion, at least one of the first outer metal portion, the first inner metal portion and the first rubber portion having a first tapered end;
a second component having a second outer metal portion, a second inner metal portion and a second rubber portion concentrically arranged around each other, the second rubber portion spacing apart the second outer metal portion from the second inner metal portion, at least one of the second outer metal portion, the second inner metal portion and the second rubber portion having a second tapered end; and
a fastener configured to connect the first tapered end of the first component and the second tapered end of the second component, the first component and the second component configured to at least partially overlap wherein the bushing assembly forms a bottleneck shaped center portion when fully assembled

19. The leaf spring assembly of claim 18 wherein the first and second outer metal portions are concentrically arranged around the respective first and second rubber portions.

20. The leaf spring assembly of claim 18 wherein the first and second rubber portions are concentrically arranged around the respective first and second inner metal portion.
